(19) United States
(12) Patent Application Publication
(10) Pub. No.: US 2002/0015756 A1
(43) Pub. Date: Feb. 7, 2002

(54) MIXTURE FOR THE PREPARATION OF ICE CREAM

(76) Inventor: EVGENY ANATOLIEVICH GUTKEVICH, TOMSK (RU)

Correspondence Address: JOHN B HARDAWAY III, HARDAWAY MANN, NEXSEN PRUET JACOBS & POLLARD, PO BOX 10107 FED STATION, GREENVILLE, SC, 296030107

(21) Appl. No.: 09/319,315

(22) PCT Filed: Jul. 23, 1997
(86) PCT No.: PCT/RU97/00232

(30) Foreign Application Priority Data
Feb. 12, 1996 (RU) 96122896

(51) Int. Cl. A23C 9/12

(52) U.S. Cl. 426/34

(57) ABSTRACT

The proposed ice cream production mix comprises a milk base, a sweetener, a stabilizer, and probiotic microorganisms, e.g., selected from the group consisting of Lactobacillus acidophilus, Lactobacillus casei, Lactobacillus rhamnosus, Enterococcus faecium, and Bacterium bifidum, taken either separately or in combination.

### TECHNICAL FIELD

The present invention relates generally to the dairy industry and more specifically to a mix for ice cream production.

### BACKGROUND ART

A great many ice cream varieties are heretofore known to differ in the content of such ingredients as fats, flavors, sweeteners, fillers, and so on.

Each ice cream features unique palatability and consumer properties dependent on a specific composition of ingredients contained therein.

For instance, an ice cream is known (cf. a technological instructions on ice cream production, Moscow, “V/O Agropomizdat”, 1988, pp.111, 114, 116 (in Russian) to comprise a milk base, lactic-acid microorganisms Str. citrovorus, Str. dextanicus, Str. cremoris, and fruit fillers.

Use of said microorganisms is aimed mainly at fermenting the milk base and preparing a fermented-milk product which apart from imparting a unique fruit flavor to ice cream, also contributes to better digestion.

However, the aforementioned lactic-acid microorganisms possess but a limited biological activity and render but a transient positive effect on human organism, because once having got into the gastrointestinal tract they as a rule perish rapidly.

### DISCLOSURE OF THE INVENTION

The present invention has for its primary and essential object to provide a mix for producing ice cream incorporating such ingredients that not only impart unique palatability to ice cream but also add to its biological activity and health-giving properties to human organism.

The foregoing object is accomplished due to the provision of a mix for ice-cream production, comprising the following ingredients: a milk base, a sweetener, a stabilizer, and microorganisms wherein, according to the invention, said microorganisms are probiotic microorganisms.

Probiotic microorganisms are in fact a group of microorganisms able to exist in human organism and to positively influence man's health by way of participating in organism's metabolism.

Unlike lactic-acid bacteria used for milk fermentation and producing a fermented-milk product, probiotic microorganisms having got into human organism start reproducing, thus rendering a positive effect on human organism while not affecting palatability of ice cream.

Presence of probiotic microorganisms in ice cream adds to its biological activity and allows of harmonically combining trade appeal and palatability of ice cream with a curative and prophylactic effect produced by said microorganisms on human organism.

The curative and prophylactic effect of probiotic microorganisms is produced in the duodenum, ileum, caecum, and rectum of human organism, where said microorganisms reproduce and start participate in human metabolism as early as three to five hours after their penetration in human organism, their maximum activity occurring in four-six hours thereafter (cf. a paper entitled “Intestinal Bacteria and Health” by T. Mitsuoka, published in 1978).

The duration of maximum activity of probiotic microorganisms in human organism falls within a period of from 24 to 72 hours.

As has been stated hereinbefore, the curative and prophylactic effect of probiotic microorganisms is determined by their participation in the metabolism of human organism which stimulates the immune system, reduces the blood cholesterol content, suppresses the development of pathogenic intestinal microflora, adds to calcium absorption, and improves food assimilation.

It is expedient that the proposed mix should contain the aforementioned ingredients taken in the following ratio (on the weight-percent basis):

| | |
|---|---|
| probiotic microorganisms | from 0.01 to 10.0 |
| stabilizer | from 0.4 to 5.0 |
| sweetener | from 0.5 to 20.0 |
| milk base | being the balance. |

The foregoing amount of ingredients allows of producing both a dry mix for preparing ice cream and a “wet” mix therefor.

The dry mix is simple to prepare, readily storable for a prolonged period of time, compactly packaged, whereby it is expedient to be used for transporting to far-removed territories.

“Wet” mix is convenient in that ice cream is produced in ready-to-use state and is quickly realizable.

It is desirable that the proposed mix should further contain water and incorporate dried fat-free milk as the milk base, the ratio between the ingredients being as follows (on the weight-percent basis):

| | |
|---|---|
| dried fat-free milk | from 8.0 to 20.0 |
| whole milk | from 30.0 to 44.0 |
| sweetener | from 0.5 to 20.0 |
| stabilizer | from 0.4 to 5.0 |
| probiotic microorganisms | from 0.001 to 10.0 |
| water | being the balance. |

Provision of the aforesaid ingredients in the above-specified ratio allows of producing ice cream in a widest palatability range and featuring the aforestated health-giving properties.

It is favorable that the herein-proposed mix should further comprise a yoghurt culture, the ratio between the ingredients being as follows (on the weight-percent basis):

| | |
|---|---|
| dried fat-free milk | from 8.0 to 20.0 |
| whole milk | from 40.0 to 44.0 |
| sweetener | from 0.5 to 20.0 |
| stabilizer | from 0.4 to 5.0 |
| probiotic microorganisms | from 0.001 to 3.4 |
| yoghurt culture | from 1.0 to 4.0 |
| water | being the balance. |

Provision of the yoghurt culture in said mix with the afore-specified ratio between the ingredients thereof makes it possible to utilize the afore-described positive effect derived from the presence of lactic-acid bacteria, that is, to enrich ice-cream palatability with the properties of a fermented-milk product.

It is reasonable that the proposed mix should comprise the following groups of said microorganisms as the probiotic microorganisms:

Lactobacillus acidophilus

Lactobacillus casei

Lactobacillus rhamnosus

Enterococcus faecium

Bacterium bifidum

taken either separately or in combination.

The foregoing groups of probiotic microorganisms are the most efficacious, in terms of their biologically active effect produced on human organism, among the heretofore-known probiotic microorganisms which are described in most detail in the aforementioned paper by T. Mitsuoka.

Thus, the proposed mix for ice cream production allows of not only imparting unique palatability to ice cream but also adding to its biological activity and health-giving properties to human organism.

### BEST METHOD FOR CARRYING OUT THE INVENTION

The proposed mix for ice cream production comprises the following ingredients: a milk base, sweetener, stabilizer, and probiotic microorganisms.

The proposed mix may comprise said ingredients taken in the following ratio (on the weight-percent basis):

| | |
|---|---|
| probiotic microorganisms | from 0.01 to 10.0 |
| stabilizer | from 0.4 to 5.0 |
| sweetener | from 0.5 to 20.0 |
| milk base | being the balance. |

In addition, said mix may further comprise water and, as the milk base it may contain dried fat-free milk, the ratio between the ingredients being as follows (on the weight-percent basis):

| | |
|---|---|
| dried fat-free milk | from 8.0 to 20.0 |
| whole milk | from 30.0 to 44.0 |
| sweetener | from 0.5 to 20.0 |
| stabilizer | from 0.4 to 5.0 |
| probiotic microorganisms | from 0.001 to 10.0 |
| water | being the balance. |

The mix may likewise further comprise a yoghurt culture, the ratio between the ingredients being as follows (on the weight-percent basis):

| | |
|---|---|
| dried fat-free milk | from 8.0 to 20.0 |
| whole milk | from 40.0 to 44.0 |
| sweetener | from 0.5 to 20.0 |
| stabilizer | from 0.4 to 5.0 |
| probiotic microorganisms | from 0.001 to 3.4 |
| yoghurt culture | from 1.0 to 4.0 |
| water | being the balance. |

The proposed mix may comprise the following groups of said microorganisms as the probiotic microorganisms:

Lactobacillus acidophilus

Lactobacillus casei

Lactobacillus rhamnosus

Enterococcus faecium

Bacterium bifidum

taken either separately or in combination.

According to the invention, the proposed mix for ice cream production may be either dry prepackaged in bags or traditionally “wet”.

Probiotic microorganisms are added to the mix in, as a rule, lyophilized state and can be stored as such until ice cream is prepared therefrom and used.

In traditional “wet” ice cream the lyophilized microorganisms are as rule added to the mix before its being frozen and hardened.

When both in a frozen and a lyophilized state probiotic microorganisms remain viable and active so long as ice cream is taken in as food.

Both dry and “wet” mixes can be prepared by any one of the heretofore-known techniques using equipment suitable for the purpose. Specific variants of the process technique used are described in detail hereinbelow with reference to specific exemplary embodiments of the present invention.

The proposed mix for ice cream production may comprise any fillers, such as flavors, fruits, nuts, chocolate, and the like.

Used as the milk base may be dried fat-free milk, dried whole milk, dried milk having various fat content, dried cream, whole milk of any fat content, concentrated milk, concentrated cream, condensed milk of any fat content, condensed cream of any fat content, and any other milk.

Milk per se imparts to ice cream excellent tastiness and useful substances contained therein.

Used as the sweetener may be such extensively known substances as sugar, aspartate, xylitol, or any other heretofore-known sweetener on the use of which depends the palatability of the end product.

It is the ice cream stabilizer PRO-QUICK available from TEWS GmbH (Germany) that is most efficient to be used, though any other stabilizers (e.g., starch) suitable for the purpose can be made use of. Use of a stabilizer in ice cream improves its consistency.

Consistency of “wet” ice cream is governed by the amount of a liquid ingredient (i.e., water and/or whole milk).

Provision of a yoghurt starter in the proposed mix is aimed at milk fermenting. Used as a starter culture may be that available from the Institute of the Dairy Industry in the City of Omsk, and yoghurt starters from Wiesby and CHR Hansen (Germany), though use can be made of any other starter cultures used for milk fermenting. Lyophilized forms of the aforementioned probiotic microorganisms are available from diverse manufacturers, in particular, the Institute of Vaccines and Sera in the City of Tomsk, as well as the above-mentioned German companies Wiesby and CHR HANSEN. The effect obtained from use of the probiotic microorganisms has been described before. Use of liquid forms of said probiotic microorganisms is also possible.

To attain a high level of biological activity of the desired product, it is expedient that it contains an adequate amount of the probiotic microorganisms. With said purpose in view, it is important that the concentration of probiotic cells in the proposed mix equals one or two therapeutic doses (that is, about 1×10⁷ cells per 100 g of the product); this being the case, a maximum biological activity of the finished product is attained.

Overdosage of the probiotic cells is impossible, since part of the cells are liable to perish in the stomach due to their being exposed to the effect of gastric juice; upon getting in other portions of the gastrointestinal tract the probiotic cells start reproducing, while the reproduction rate and the amount of probiotic cells in the organism is self-regulated, that is, such an amount of cells are functioning in the organism that it requires at a given instant (cf. T. Mitsuoka, op. cit.).

An optimum concentration of probiotic microorganisms has been described hereinbefore. With their content below 0.01 wt. %, the amount of their cells per 100 g of the finished product will be below about 10⁵ which affects adversely the biologic activity of the product. With the concentration of the probiotic microorganisms above 10 wt. %, 100 g of the finished product will contain about 10⁸ cells of the probiotic microorganisms which might affect the palatability of the finished product.

The amount of the sweetener is dictated by a desired tastiness of the product. When the concentration of the sweetener is below 0.5 wt. % ice cream might lose its palatability while with the sweetener content above 20 wt. % ice cream becomes sickly sweet and, moreover, too a high sugar content may tells badly on the general state of organism (due to overloading the pancreas).

Provision of a stabilizer in ice cream is indispensable for binding water therein and imparting elastic consistency thereto. With the stabilizer concentration in the mix below 0.4 wt. %, ice cream has a soggy taste and consistency with ice crystals, whereas with the stabilizer concentration above 2.5 wt. % ice cream may have a taste of stabilizer and too a thick consistency.

Use of dried fat-free milk (8 to 20 wt. %) is made for balancing the ice cream composition in terms of milk protein content. When the milk content of the mix is below 8 wt. %, the milk protein is deficient therein which may affect tastiness of the finished product. With the dried fat-free milk concentration exceeding 20 wt. % ice cream may have the taste of dried milk which also affects the tastiness of the finished product.

Whole milk (from 40 to 44 wt. %) is used as a solvent and a source of fat. With the whole milk content below 40 wt. % the finished product may be fat-deficient, with the result that the nutritious value of the product will be reduced, whereas the whole milk content above 44 wt. % may affect tastiness of the ice cream produced.

To promote understanding of the present invention, given below are the following exemplary embodiments thereof that place no limitation upon the scope of the present invention.

### Example 1

A dry ice-cream mix is prepared using any one of the heretofore-known techniques.

For instance, dried milk, sugar, a stabilizer, and probiotic microorganisms are charged into a vat or any other container, whereupon the resultant dry ice-cream mix is thoroughly stirred and prepackaged, using any known technique, in bags by, e.g., 50 g of the mix per bag.

The resultant dry ice-cream mix has the following composition (on the weight-percent basis):

| | |
|---|---|
| stabilizer | 0.4 |
| sugar | 2.5 |
| Bacterium bifidum | 0.01 |
| dried milk | being the balance. |

Ice cream for immediate use can be prepared either under domestic conditions or at public catering establishments. A portion of the dry ice-cream mix is doped with 50 g water, and is beaten in a mixer, placed in a refrigerator for 15 to 20 seconds, then in a freezer for, e.g., one hour after which ice cream is ready for use.

The amount of viable cells of Bacterium bifidum in the ice cream is calculated using the colony-forming unit (CFU) determining technique after ice-cream defrosting.

100 g of the ice cream contains 5×10⁴ cells of Bacterium bifidum. Thus, ingesting 100 gram of ice cream three times a day for ten days, human organism receives a total of 3×10×5×10⁴=150×10⁴=1.5×10⁶ cells of Bacterium bifidum.

### Example 2

A dry ice-cream mix is prepared as described in Example 1 and has the following composition (on the weight percent basis):

| | |
|---|---|
| stabilizer | 5.0 |
| sugar | 0.5 |
| Bacterium bifidum | 2.0 |
| Lactobacillus acidophilus | 2.0 |
| Lactobacillus casei | 2.0 |
| Lactobacillus rhamnosus | 2.0 |
| Enterococcus faecium | 2.0 |
| dried milk | being the balance. |

Ice cream is prepared from the dry ice-cream mix as described in Example 1. The amount of viable probiotic microorganisms is assessed using the same technique as in Example 1.

100 g of the ice cream contains 5×10⁸ cells of the probiotic microorganisms.

Thus, having ingested as little as 10 g of ice cream, one's organism receives one therapeutic dose (1×10⁷) of the probiotic microorganisms.

### Example 3

A dry ice-cream mix is prepared as described in Example 1 so long as probiotic microorganisms are added thereto, using any equipment suitable for the purpose.

The following process technique may be used for ice-cream mix preparation.

Dried milk, sugar, and a stabilizer are intermixed in a vat and the resultant mix is added, under constant stirring, gradually to whole milk which is then heated up to 40° C. Once the dry matter has dissolved in the milk, the mix is left for swelling under constant stirring for, e.g. 10 minutes. Then the mix is passed through a homogenizer for a more complete dissolution and obtaining a homogeneous mass of the mix (e.g., at a pressure of 160/40 bar). Thereupon the mix is pasteurized by, e.g., being heated up to 85° C., cooled down to the ambient temperature, and doped, under thorough stirring, with the probiotic microorganisms.

Finally, the mix is frozen in a conventional way and apportioned, after which the portions are hardened to a temperature of, e.g., minus 25° C.

The ice-cream mix has the following composition (on the weight-percent basis):

| | |
|---|---|
| dried fat-free milk | 8.0 |
| whole milk | 44.0 |
| aspartate | 0.5 |
| Bacterium bifidum | 5.0 |
| Lactobacillus acidophilus | 5.0 |
| stabilizer | 0.4 |
| water | being the balance. |

Before determining the amount of viable cells of the probiotic microorganisms per 100 g of ice cream, the latter is to be stored at a temperature of minus 25° C. for a month.

The amount of viable cells is calculated using the CFU determining technique as in Example 1.

100 g of the ice cream contains 10⁸ viable cells of Bacterium bifidum and cells of Lactobacillus acidophilus.

Thus, ingesting 100 g of ice cream that has been stored at a temperature of 25° C. for a month, results in that human organism receives 10⁸ cells of the probiotic microorganisms.

### Example 4

An ice cream mix comprises the following ingredients taken in the following ratio therebetween (on the weight percent basis):

| | |
|---|---|
| dried fat-free milk | 20.0 |
| whole milk | 30.0 |
| Enterococcus faecium | 0.005 |
| Lactobacillus casei | 0.005 |
| xylitol | 20.0 |
| stabilizer | 5.0 |
| water | being the balance. |

Ice cream is prepared as in Example 3, the amount of viable probiotic microorganisms is calculated using the CFU determining technique.

100 g of ice cream comprises 10⁵ cells of the probiotic microorganisms.

Thus, ingesting 100 gram of ice cream three times a day for twenty days results in that human organism receives a total of 10^{5×3×20=6×10}⁷ cells of probiotic microorganisms.

### Example 5

The ice cream mix comprises the following ingredients taken in the following ratio (on the weight percent basis):

| | |
|---|---|
| dried fat-free milk | 8.0 |
| whole milk | 40.0 |
| Lactobacillus casei | 0.2 |
| sugar | 20 |
| stabilizer | 2.5 |
| yoghurt culture | 1.0 |
| water | being the balance. |

The ice cream preparation process is conducted as in Example 3 so far as the step of cooling the mix down to the ambient temperature, whereupon the yoghurt culture is added thereto for the mix to be fermented for 10 to 15 hours until the pH value of 4.5 is attained after which the probiotic microorganisms are inoculated. The steps of freezing, apportioning, hardening, and storing the finished ice cream are as in Example 3.

Once a portion of the ice cream has been defrosted and the amount of viable cells of the probiotic microorganisms has been calculated using the CFU determining technique, it is found that 100 g of the product contains 2×10⁶ cells of the probiotic microorganisms. Thus, ingesting 100 g of the ice cream two times a day for five days results in that human organism receives a total of 2×10⁶×2×5=2×107 cells of Lactobacillus casei.

### Example 6

An ice cream mix contains the following ingredients taken in the following ratio therebetween (on the weight percent basis):

| | |
|---|---|
| dried fat-free milk | 20.0 |
| whole milk | 44.0 |
| Enterococcus faecium | 3.4 |
| xylitol | 10 |
| stabilizer | 2.0 |
| yoghurt culture | 4.0 |
| water | being the balance. |

The mix is prepared as in Example 5. Once the ice cream has been defrosted and the amount of viable cells of Enterococcus faecium has been determined, 100 g of the product is found to contain 3.4×10⁷ cells of said microorganism.

### Industrial Applicability

The present invention is used to good advantage for producing ice cream having various fat content values (e.g., dairy ice cream, high-fat ice cream, plombieres), with various flavor and fruit fillers, as well as in frozen juice.

The invention is also applicable in the pharmaceutical industry as a kind of therapeutic medicinal form of probiotic microorganisms (e.g., Bacterium bifidum).

1. A mix for ice-cream production, comprising the following ingredients: a milk base, a sweetener, a stabilizer, and microorganisms, CHARACTERIZED in that said microorganisms are probiotic microorganisms.

2. The mix of claim 1, CHARACTERIZED in that it contains the aforementioned ingredients taken in the following ratio (on the weight-percent basis):

| | |
|---|---|
| probiotic microorganisms | from 0.01 to 10.0 |
| stabilizer | from 0.4 to 5.0 |
| sweetener | from 0.5 to 20.0 |
| milk base | being the balance. |

3. The mix of claim 2, CHARACTERIZED in that it further contains water and incorporates dried fat-free milk as the milk base, the ratio between the ingredients being as follows (on the weight-percent basis):

| | |
|---|---|
| dried fat-free milk | from 8.0 to 20.0 |
| whole milk | from 30.0 to 44.0 |
| sweetener | from 0.5 to 20.0 |
| stabilizer | from 0.4 to 5.0 |
| probiotic microorganisms | from 0.001 to 10.0 |
| water | being the balance. |

4. The mix of claim 3, CHARACTERIZED in that it further comprises a yoghurt culture, the ratio between the ingredients being as follows (on the weight-percent basis):

| | |
|---|---|
| dried fat-free milk | from 8.0 to 20.0 |
| whole milk | from 40.0 to 44.0 |
| sweetener | from 0.5 to 20.0 |
| stabilizer | from 0.4 to 5.0 |
| probiotic microorganisms | from 0.001 to 3.4 |
| yoghurt culture | from 1.0 to 4.0 |
| water | being the balance. |

5. The mixture according to any one of the preceding claims, CHARACTERIZED in that it comprises the following groups of said microorganisms as the probiotic microorganisms:
Lactobacillus acidophilus
Lactobacillus casei
Lactobacillus rhamnosus
Enterococcus faecium
Bacterium bifidum
taken either separately or in combination.
